(19) United States
(12) Patent Application Publication
(10) Pub. No.: US 2025/0018482 A1
(43) Pub. Date: Jan. 16, 2025

(54) BAND SAW MACHINE CAPABLE OF DETECTING TENSION OF SAW BAND

(71) Applicant: OAV EQUIPMENT AND TOOLS, INC., TAICHUNG CITY (TW)

(72) Inventor: Lung-Chang CHAN, TAICHUNG CITY (TW)

(21) Appl. No.: 18/220,585

(22) Filed: Jul. 11, 2023

(51) Int. Cl. B23D 55/10; B23D 59/00; B26D 7/22

(52) U.S. Cl. CPC B23D 55/10; B23D 59/001; B26D 7/22

(57) ABSTRACT

A band saw machine includes a base, a sawing unit, a tension adjustment unit, and a tension detector. The base has a straight post, an upper wheel case connected with the straight post, and a lower wheel case connected with the straight post. The sawing unit has an upper axle vertically movably disposed in the upper wheel case, an upper wheel rotatably connected to the upper axle, a lower axle disposed in the lower wheel case, a lower wheel rotatably connected to the lower axle, and a saw band wound around the upper and the lower wheels. The tension adjustment unit is disposed to the base and connected to the upper axle for pushing the upper axle to move upwards. The tension detector is disposed to the upper axle and detects a minor deformation of the upper axle for accurately detecting the current tension of the saw band.

### BACKGROUND OF THE INVENTION

### 1. Field of the Invention

The present invention relates to a band saw machine and more particularly, to a vertical band saw machine that can accurately detect the tension of a saw band.

### 2. Description of the Related Art

Before operating a vertical band saw machine to saw a workpiece, an operator needs to adjust a saw band of the vertical band saw machine to a suitable tension. If the tension of the saw band is too large, the saw band breaks easily during sawing, but if the tension of the saw band is insufficient, a problem that a saw line is not straight or the saw band comes off may occur. On the other side, the saw band needs to be adjusted to different tensions according to different sizes of the saw bands or different to-be-processed materials. For example, a to-be-sawed workpiece is made of cast iron with higher hardness or aluminum alloy with lower hardness.

As far as the inventor knows. the current band saw machine cannot accurately detect the tension of the saw band, such that it is difficult for the operator to adjust the saw band to a correct tension for sawing. Thus, the design of the current band saw machine is not perfect and there is still room for improvement.

### SUMMARY OF THE INVENTION

It is a primary objective of the present invention to provide a band saw machine, which can effectively and accurately detect the tension of a saw band for facilitating an operator to adjust the saw band to a correct tension.

To attain the above objective, the band saw machine of the present invention comprises a base, a sawing unit, a tension adjustment unit, and a tension detector. The base has a straight post, an upper wheel case connected with the straight post, and a lower wheel case connected with the straight post and spaced from the upper wheel case. The sawing unit includes an upper axle vertically movably disposed in the upper wheel case, an upper wheel rotatably connected to the upper axle, a lower axle disposed in the lower wheel case, a lower wheel rotatably connected to the lower axle, and a saw band wound around the upper wheel and the lower wheel. The tension adjustment unit is disposed in the base and connected to the upper axle for pushing the upper axle to move upwards. The tension detector is disposed to the upper axle and detects a minor deformation of the upper axle.

In one aspect, the upper wheel case includes an adjustment base provided with a threaded hole. The tension adjustment unit includes a lifting block fixed to the upper axle and an adjustment screw threaded with the threaded hole of the adjustment base and pushing the lifting block to move upwards for adjusting the tension of the saw band.

Specifically, the tension adjustment unit further includes a compression spring sleeved on the adjustment screw and protruding out of a top end of the adjustment screw. The adjustment screw pushes the lifting block to move upwards through the compression spring for providing a buffer force.

Specifically, the adjustment screw is connected to an abutment block. The compression spring is sleeved on the adjustment screw and has two ends thereof abutted against the lifting block and the abutment block, respectively.

In another aspect, the band saw machine further comprises a driving motor disposed in the lower wheel and having a power output shaft, a first belt pulley coaxially connected to the upper wheel, a second belt pulley coaxially connected to the power output shaft, and a belt wound around the first belt pulley and the second belt pulley. In this way, the driving motor can drive the lower wheel to rotate through the belt and the two belt wheels, thus driving the saw band for sawing operation.

In another aspect. the band saw machine further comprises an indicating unit disposed to the base and a control chip electrically connected to the tension detector and controlling the indicating unit to indicate tension information of the saw band according to the minor deformation detected by the tension detector. In this way, the operator can adjust conveniently the tension adjustment unit through the indicating unit to adjust the tension of the saw band.

Specifically, the indicating unit can be one or more indicator lights. The control chip controls the indicator light to turn on or off according to the minor deformation detected by the tension detector, thereby indicating whether the tension of the saw band is adjusted to a desired value.

In another aspect, the control chip is electrically connected to the tension detector via a wired connection. If the tension detector is installed in other positions of the band saw machine, the signal detected by the tension detector can be transmitted wirelessly to the control chip.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a band saw machine of the present invention.

FIG. 2 is similar to FIG. 1, showing that the case covers of the upper and lower wheel cases are opened.

FIG. 3 is an enlarged view of FIG. 2, in which the upper wheel and the saw band are omitted.

FIG. 4 is a partially sectional view of FIG. 2.

FIG. 5 is an enlarged view of FIG. 2.

FIG. 6 is a signal connection block diagram of the tension detector.

### DETAILED DESCRIPTION OF THE INVENTION

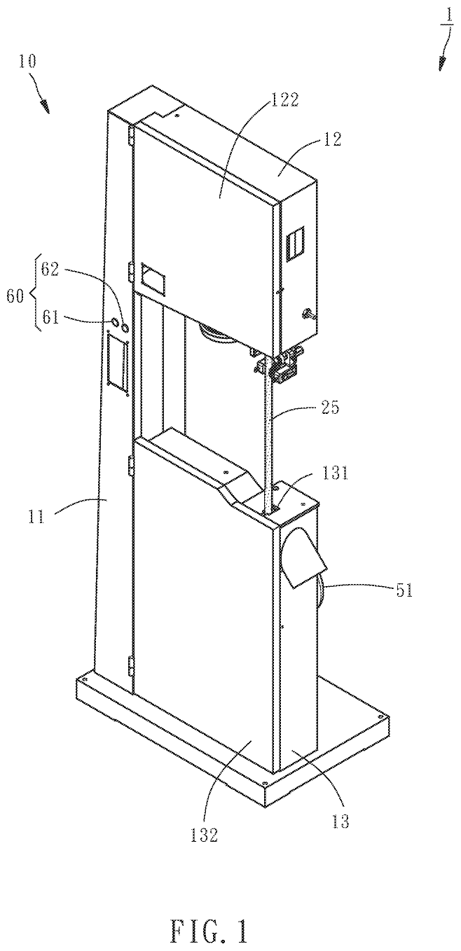

Referring to FIGS. 1 to 5, a band saw machine 1 of the present invention comprises a base 10, a sawing unit 20, a tension adjustment unit 30, and a tension detector 40.

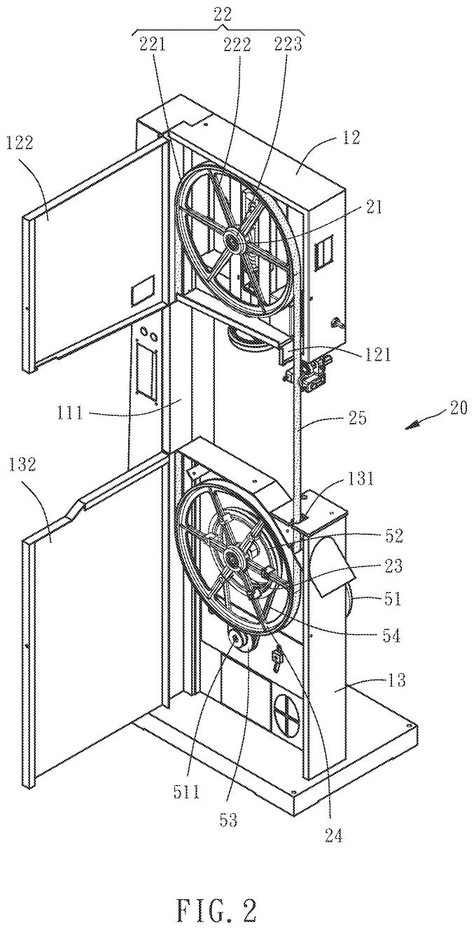

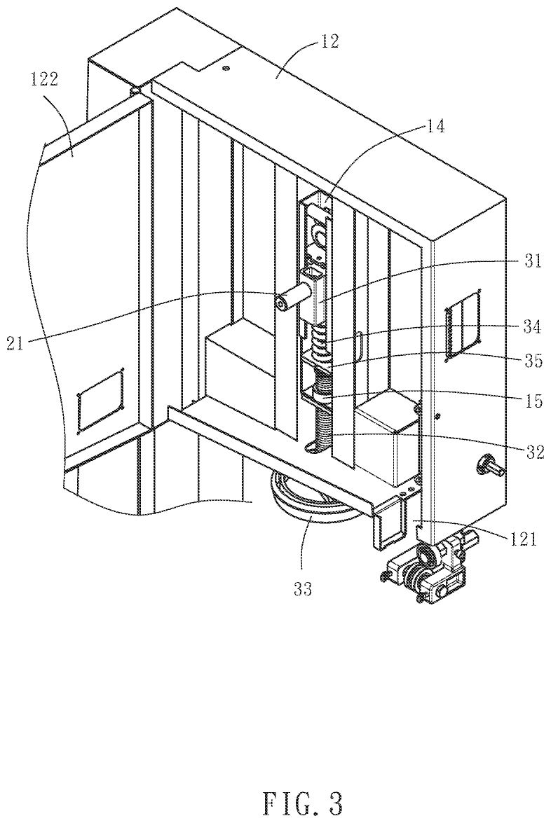

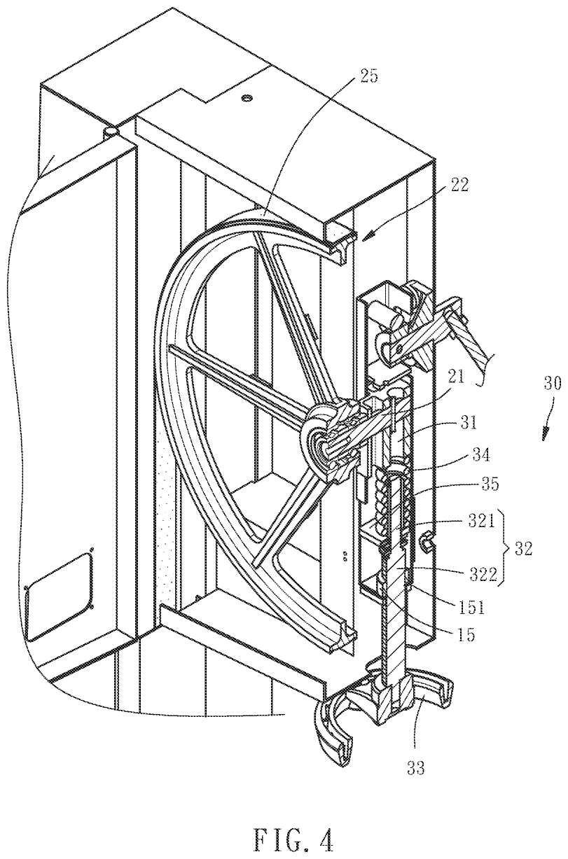

The base 10 includes a straight post 11, an upper wheel case 12, and a lower wheel case 13. The straight post 11 is hollow and communicates with the upper wheel case 12 and the lower wheel case 13. FIG. 1 is taken as a direction reference. The upper and lower wheel cases 12, 13 are connected to the right side of the straight post Il and spaced vertically from each other. The upper wheel case 12 has a lower opening 121, and the lower wheel case 13 has an upper opening 131. The lower opening 121 is located directly above the upper opening 131. The upper and lower wheel cases 12, 13 each have a case cover 122, 132 pivotally connected to the straight post 11. FIG. 2. shows that the case covers 122, 132 are opened. As shown in FIGS. 3 and 4, the upper wheel case 12 has a compartment 14 inside. An adjustment base 15 is fixed to an inner wall of the compartment 14 and provided with a threaded hole 151. It should be noted that the adjustment base 15 is disposed in the upper wheel case 12 as an example in this embodiment. In some cases, the adjustment base 15 can be connected to the outside of the upper wheel case 12 so as not to be limited to this embodiment.

As shown in FIGS. 2, 4, and 5, the sawing unit 20 includes an upper axle 21, an upper wheel 22, a lower axle 23, a lower wheel 24, and a saw band 25. The upper axle 21 is vertically movably disposed in the upper wheel case 12. The upper wheel 22 is taken as a driven wheel in this embodiment, including a wheel portion 221, six spokes 222, and a shaft portion 223. Two opposite ends of the spokes 222 are connected with the wheel portion 221 and the shaft portion 223. The shaft portion 223 is sleeved on the upper axle 21 through a bearing, such that the upper wheel 22 is rotatably mounted on the upper axle 21. The lower axle 23 is disposed in the lower wheel case 13. The lower wheel 24 is taken as a driving wheel, and the lower wheel 24 is rotatably mounted on the lower axle 23. The saw band 25 is mounted around the upper wheel 22 and the lower wheel 24. The left side of the saw band 25 is located at the right side of the straight post 11 and covered by a baffle 111. The right side of the saw band 25 passes through the lower opening 121 of the upper wheel case 12 and the upper opening 131 of the lower wheel case 13. When the lower wheel 24 is rotated, the saw band 25 is driven to move for sawing.

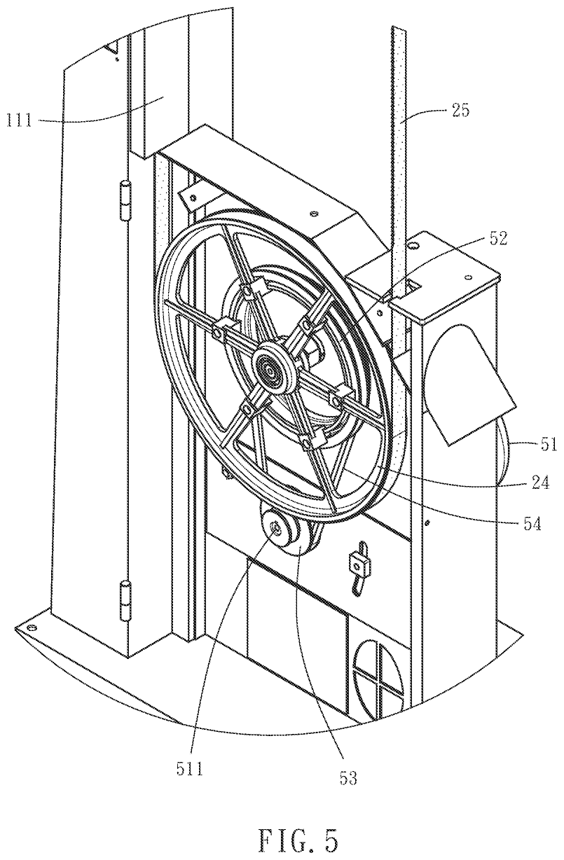

As shown in FIG. 5, in this embodiment, in order to drive the lower wheel 24 to rotate, the band saw machine 1 is equipped with a driving motor 51, a first belt pulley 52, a second belt pulley 53, and a belt 54. The driving motor 51 is installed in the lower wheel case 13 and provided with a power output shaft 511. The first belt pulley 52 is coaxially connected to the lower wheel 24. The second belt pulley 53 is coaxially connected to the power output shaft 511. The belt 54 is mounted around the first and second belt pulleys 52, 53. Therefore, when the driving motor 51 is started, the driving motor 51 drives the lower wheel 24 to rotate through the first and second belt pulleys 52, 53 and the belt 54. In some cases, the power output shaft 511 of the driving motor 51 can be taken as the lower axle 23, such that the first and second belt pulleys 52, 53 and the belt 54 can be omitted.

As shown in FIGS. 3 and 4, the tension adjustment unit 30 is disposed to the upper wheel case 12 of the base 10 and connected to the upper axle 21 for pushing the upper axle 21 to move upwards, such that the upper wheel 22 can push the saw band 25 upwards, thereby adjusting the tension of the saw band 25. Specifically, in this embodiment, the tension adjustment unit 30 includes a lifting block 31, an adjustment screw 32, a hand wheel 33, and a compression spring 34. The lifting block 31 is vertically movably disposed in the compartment 14 of the upper wheel case 12 and fixed to the upper axle 21. The adjustment screw 32 has a top portion 321 and a threaded portion 322 threaded with the threaded hole 151 of the adjustment base 15. A step difference is formed between the top portion 321 and the threaded portion 322 to be connected with an abutment block 35. The compression spring 34 is sleeved on the top portion 321 of the adjustment screw 32 and protrudes out of the top portion 321. Two ends of the compression spring 34 are abutted against the lifting block 31 and the abutment block 35, respectively. The hand wheel 33 is located below the upper wheel case 12 and connected with the bottom end of the adjustment screw 32. When the hand wheel 33 is rotated by the operator. the adjustment screw 32 pushes the lifting block 31 and the upper wheel 22 connected with the lifting block 31 upwards through the abutment block 35 and the compression spring 34. It should be noted that the compression spring 34 is not required. In some cases, the compression spring 34 can be omitted, so that the adjustment screw 32 is directly connected with the lifting block 31. Therefore, it should not be limited to this embodiment.

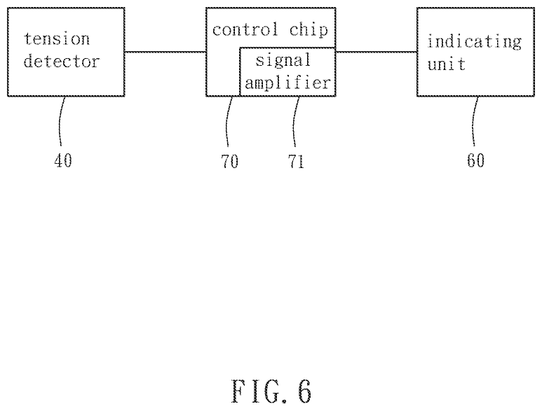

The tension detector 40 is used to detect the tension of the saw band 25 when the saw band 25 is wound around the upper and lower wheels 22, 24. In this embodiment, the tension detector 40 is a strain gauge. The tension detector 40 is attached to the upper axle 21. When the saw band 25 is wound around the upper and lower wheels 22, 24, the upper wheel 22 applies an upward force to the saw band 25, such that the upper axle 21 is slightly deformed by the aforesaid force. The tension detector 40 detects a minor deformation of the upper axle 21 and generates a change in resistance value. At the same time, the tension detector 40 is used with a control chip 70 (see FIG. 6) electrically connected with the tension detector 40 via a wired connection. The control chip 70 is provide with a signal amplifier 71 to obtain the change in resistance value. The aforesaid resistance value and the current tension of the saw band 25 have a corresponding relationship. In some cases, a piezoelectric sensor or capacitive sensor can be taken as the tension detector 40.

In order to indicate the tension information of the saw band 25 to the operator and let the operator know whether the current tension is enough, an indicating unit 60 (as shown in FIG. 1) is provided at the front side of the straight post 11. The indicating unit 60 is two indicator lights 61, 62 in this embodiment. The two indicator lights 61, 62 emit red light and green light, respectively. When the control chip 70 obtains the tension information of the saw band 25 through the tension detector 40, if the tension of the saw band 25 is insufficient, the control chip 70 controls the indicator light 61 that emits red light to turn on and controls the indicator light 62 that emits green light to turn off. On the contrary, if the tension of the saw band 25 is sufficient (or correct), the control chip 70 controls the indicator light 62 that emits green light to turn on and controls the indicator light 61 that emits red light to turn off.

It should be noted that the indicating unit 60 takes two indicator lights 61, 62 as an example in this embodiment. However, the indicating unit 60 can be a LED that emits light or a display screen capable of displaying numerical values. The indicating unit 60 also can be a virtual indicator light on a screen of a mobile phone that transmits the tension detected by the tension detector 40 to an APP of the mobile phone through a Wi-Fi connection, thereby displaying or turning off the virtual indicator light. Therefore, it should not be limited to this embodiment.

By means of the structural design of the band saw machine 1 of the present invention, the operator can adjust the tension of the saw band 25 through the tension adjustment unit 30 on one hand, and on the other hand, the operator can obtain the tension information of the saw band 25 through the tension detector 40 for facilitating the operator to adjust the saw band 25 to a correct and suitable tension.

It is worth noting that since the spokes 222 of the upper wheel 22 and the lower axle 23 can be slightly deformed by the tension of the saw band 25, the tension detector 40 can be attached to the spokes 222 of the upper wheel 22 or the lower axle 23. When the tension detector 40 is attached to the spokes 222 of the upper wheel 22, the tension detector 40 can be electrically connected to the control chip 70 in a wireless connection for convenience of transmitting the signal to the control chip 70.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A band saw machine comprising:
a base including a straight post, an upper wheel case connected with the straight post, and a lower wheel case connected with the straight post and spaced from the upper wheel case;
a sawing unit including an upper axle vertically movably disposed in the upper wheel case, an upper wheel rotatably connected to the upper axle, a lower axle disposed in the lower wheel case, a lower wheel rotatably connected to the lower axle, and a saw band wound around the upper wheel and the lower wheel;
a tension adjustment unit disposed to the base and connected to the upper axle for pushing the upper axle to move upwards; and
a tension detector disposed to the upper axle and detecting a minor deformation of the upper axle.

2. The band saw machine as claimed in claim 1, wherein the upper wheel case includes an adjustment base provided with a threaded hole; the tension adjustment unit includes a lifting block fixed to the upper axle and an adjustment screw threaded with the threaded hole of the adjustment base and pushing the lifting block to move upwards.

3. The band saw machine as claimed in claim 2, wherein the tension adjustment unit further includes a compression spring sleeved on the adjustment screw and protruding out of a top end of the adjustment screw; the adjustment screw pushes the lifting block to move upwards through the compression spring.

4. The band saw machine as claimed in claim 3, wherein the adjustment screw is connected to an abutment block; the compression spring is sleeved on the adjustment screw and has two ends thereof abutted against the lifting block and the abutment block, respectively.

5. The band saw machine as claimed in claim 1, further comprising a driving motor disposed in the lower wheel case and having a power output shaft, a first belt pulley coaxially connected to the upper wheel, a second belt pulley coaxially connected to the power output shaft, and a belt wound around the first belt pulley and the second belt pulley.

6. The band saw machine as claimed in claim 1, further comprising a driving motor disposed in the lower wheel case and having a power output shaft that is the lower axle.

7. The band saw machine as claimed in claim 1, further comprising an indicating unit and a control chip electrically connected to the tension detector and controlling the indicating unit to indicate tension information of the saw band according to the minor deformation detected by the tension detector.

8. The band saw machine as claimed in claim 7, wherein the indicating unit is an indicator light disposed in the base; the control chip controls the indicator light to turn on or off according to the minor deformation detected by the tension detector.

9. The band saw machine as claimed in claim 8, wherein the control chip is electrically connected to the tension detector via a wired connection.

10. A band saw machine comprising:
a base including a straight post, an upper wheel case connected with the straight post, and a lower wheel case connected with the straight post and spaced from the upper wheel case;
a sawing unit including an upper axle vertically movably disposed in the upper wheel case, an upper wheel rotatably connected to the upper axle and having a wheel portion, a shaft portion, and a plurality of spokes connected with the wheel portion and the shaft portion, a lower axle disposed in the lower wheel case, a lower wheel rotatably connected to the lower axle, and a saw band wound around the upper wheel and the lower wheel;
a tension adjustment unit disposed to the base and connected to the upper axle for pushing the upper axle to move upwards; and
a tension detector disposed to one of the spokes and detecting a minor deformation of the corresponding spoke.

11. A band saw machine comprising:
a base including a straight post, an upper wheel case connected with the straight post, and a lower wheel case connected with the straight post and spaced from the upper wheel case:
a sawing unit including an upper axle vertically movably disposed in the upper wheel case, an upper wheel rotatably connected to the upper axle, a lower axle disposed in the lower wheel case, a lower wheel rotatably connected to the lower axle, and a saw band wound around the upper wheel and the lower wheel;
a tension adjustment unit disposed to the base and connected to the upper axle for pushing the upper axle to move upwards; and
a tension detector disposed to the lower axle and detecting a minor deformation of the lower axle.
